(19) United States
(12) Patent Application Publication
(10) Pub. No.: US 2017/0174496 A1
(43) Pub. Date: Jun. 22, 2017

(54) BEVERAGE TAP HANDLE SYSTEM WITH EMBEDDED DISPLAY SCREEN

(71) Applicant: TAPHANDLES LLC, Seattle, WA (US)

(72) Inventors: Colin Gold, Seattle, WA (US); David Kaplan, Seattle, WA (US); James Clark, Seattle, WA (US); Julian Power, Seattle, WA (US); Marcus Alan Latham, Seattle, WA (US)

(21) Appl. No.: 14/975,053

(22) Filed: Dec. 18, 2015

(51) Int. Cl. B67D 1/08; B67D 1/14; G06F 3/14; H04N 5/44; G06F 3/041; G06F 3/0338; B67D 1/06; H04N 5/64

(52) U.S. Cl. CPC B67D 1/0877; B67D 1/06; B67D 1/0874; B67D 1/1477; H04N 5/64; H04N 5/4403; G06F 3/041; G06F 3/0338; G06F 3/1423

(57) ABSTRACT

The present disclosure provides apparatuses and methods related to a beverage tap handle that is capable of displaying videos proactively and retroactively based on environmental triggers. In a general embodiment, a beverage tap handle includes a handle portion that can be pulled to dispense a beverage from a spigot, an attachment portion that attaches the handle portion to the spigot, a display screen configured to display a plurality of images, and a controller that controls the display screen to change an image displayed on the display screen to a new image from the plurality of images, the controller programmed to (i) change the displayed image to the new image when the handle portion is pulled sideways to dispense the beverage; and/or (ii) change the displayed image to the new image after the displayed image has been displayed for a predetermined amount of time.

### FIELD OF THE INVENTION

The present disclosure generally relates to apparatuses and methods related to a beverage tap handle associated with a display screen, and more specifically to a beverage tap handle that is capable of displaying videos proactively and retroactively based on environmental triggers.

### BACKGROUND

In many beer dispensing systems, beer is contained in a keg and is fed by a flexible tube to a beer tap from which the beer can be dispensed. The keg is tapped with a tapping head having a beer outlet connected to the flexible tube and a gas inlet for pressurized gas. The flexible tube is attached to the beer tap, which controls the release of beer by opening a spigot using a handle. The handle acts as a lever and can be pulled sideways to open the spigot, which causes the beer to flow through the flexible tube and out of the spigot due to the pressurization of the keg by the pressurized gas.

Typically, several spigots are built into a bar, either in a commercial setting or a home setting, so that different types of beer can be dispensed from each of the spigots. When one keg is emptied, a new keg can be attached to each spigot so that the beer in the new keg can be dispensed. The types of kegs attached to each spigot are frequently alternated due to changing seasons, availability, customer preferences and various other reasons. The handle attached to each spigot can also be alternated, for example, so that the handle corresponds to the keg attached to the spigot.

### SUMMARY

The present disclosure provides apparatuses and methods related to a beverage tap handle that is capable of displaying videos proactively and retroactively based on environmental triggers. In a general embodiment, a beverage tap handle includes a handle portion that can be pulled to dispense a beverage from a spigot, an attachment portion that attaches the handle portion to the spigot, a display screen configured to display a plurality of images, and a controller that controls the display screen to change an image displayed on the display screen to a new image, the controller programmed to (i) change the displayed image to the new image when the handle portion is pulled to dispense the beverage, and/or (ii) change the displayed image to the new image after the displayed image has been displayed for a predetermined amount of time.

In another embodiment, the beverage tap handle system includes a tower, wherein the spigot attaches the handle portion to the tower, and the display screen is located on the tower.

In another embodiment, the display screen is a first display screen, and which includes a second display screen located on the handle portion.

In another embodiment, the display screen is located on the handle portion.

In another embodiment, the beverage tap handle system includes a motion device that triggers the controller to change the displayed image to the new image when the handle portion is pulled to dispense the beverage.

In another embodiment, the beverage tap handle system includes a wireless antenna, and the controller is further programmed to change the displayed image to the new image when a signal is received by the wireless antenna.

In another embodiment, the display screen includes a touch screen, and the controller is further programmed to change the displayed image to the new image when the touch screen is touched.

In another embodiment, the beverage tap handle system includes a storage device that stores the plurality of images.

In another embodiment, the plurality of images includes at least one of: (i) a still image; (ii) a moving image; (iii) a video; and (iv) a text image.

In another embodiment, the beverage tap handle system includes a global positioning system (“GPS”) sensor, and the new image is based on a reading from the GPS sensor.

In another embodiment, the handle portion is configured to swivel about the attachment portion so that the display screen can be oriented in a plurality of directions.

In another embodiment, the new image is a predetermined image.

In a general embodiment, a beverage tap handle system includes a handle portion that can be pulled to dispense a beverage from a spigot, an attachment portion that attaches the handle portion to the spigot, a display screen configured to display a plurality of images, and a motion device that triggers the display screen to change an image displayed on the display screen to a new image when the handle portion is pulled to dispense the beverage.

In another embodiment, the beverage tap handle system includes a tower, wherein the spigot attaches the handle portion to the tower, and the display screen is located on the tower.

In another embodiment, the display screen is a first display screen, and which includes a second display screen located on the handle portion.

In another embodiment, the display screen is located on the handle portion.

In another embodiment, the motion device includes an accelerometer.

In another embodiment, the beverage tap handle system includes a microcontroller, and the microcontroller uses the motion device to determine how much of the beverage has been dispensed from the spigot.

In another embodiment, the motion device triggers the display screen to immediately change the displayed image to the new image when the handle portion is pulled to dispense the beverage.

In another embodiment, the motion device triggers the display screen to change the displayed image to the new image after a time delay after the handle portion is pulled.

In a general embodiment, a beverage tap handle system includes a first tap handle, the first tap handle configured to be attached to a first spigot so that the first tap handle can be pulled to dispense a first beverage from the first spigot, the first tap handle including a first display screen configured to display at least one image from a plurality of images, a second tap handle, the second tap handle configured to be attached to a second spigot so that the second tap handle can be pulled to dispense a second beverage from the second spigot, the second tap handle including a second display screen configured to display at least one image from a plurality of images, and a controller configured to: (i) place the first tap handle in wireless communication with the second tap handle; and (ii) coordinate the at least one image displayed on the first display screen with the at least one image displayed on the second display screen.

In another embodiment, the controller is located at the first tap handle and/or the second tap handle.

In another embodiment, the controller is located at a remote location and wirelessly communicates with each of the first tap handle and the second tap handle.

In another embodiment, the first tap handle includes a first wireless antenna and the second tap handle includes a second wireless antenna, and wherein the first wireless antenna wirelessly communicates with the second wireless antenna to provide direct communication between the first tap handle and the second tap handle.

In another embodiment, settings for the display screen on the first tap handle can be transmitted to the second tap handle without a user having to program the settings into the second tap handle.

In another embodiment, the at least one image is loaded onto the first tap handle and then transmitted to the second tap handle by the first tap handle.

In a general embodiment, a method of programming a tap handle to display a plurality of images includes programming a display screen of the tap handle to display a plurality of images, and programming a trigger that causes the display screen to change a displayed image to a new image.

In another embodiment, the method includes loading the first image on the display screen.

In another embodiment, programming the trigger includes programming the trigger so that the display screen changes the displayed image to the new image when the tap handle is pulled to dispense a beverage.

In another embodiment, programming the trigger includes programming the trigger so that the display screen changes the displayed image to the new image after the displayed image has been displayed for a predetermined amount of time.

In another embodiment, programming the trigger includes programming the trigger so that the display screen changes the displayed image to the new image when a signal is received by a wireless antenna located on the tap handle.

In another embodiment, programming the trigger includes programming the trigger so that the display screen changes the displayed image to the new image when the display screen is touched by a user.

In another embodiment, the method includes displaying the new image based on a global positioning system (“GPS”)

In another embodiment, programming the display screen to display the plurality of images includes transmitting at least one of the plurality of images to the tap handle from another tap handle.

In another embodiment, programming the trigger includes transmitting at least one trigger setting to the tap handle from another tap handle.

Other features and advantages will be apparent from the following specification taken in conjunction with the following drawings.

### BRIEF DESCRIPTION OF THE FIGURES

Embodiments of the present disclosure will now be explained in further detail by way of example only with reference to the accompanying figures, in which:

FIG. 1 shows a front elevational view of an embodiment of a tap handle according to the present disclosure;

FIG. 2 shows a side elevational view of the tap handle of FIG. 1;

FIG. 3 shows another side elevational view of the tap handle of FIG. 1;

FIG. 4 is a flow chart illustrating an example method of programming for the tap handle of FIG. 1;

FIG. 5 is a flow chart illustrating an example method of controlling the tap handle of FIG. 1;

FIG. 6 is a schematic diagram showing an embodiment of a system for coordinating a plurality of tap handles according to the present disclosure;

FIG. 7 shows a side elevational view of an embodiment of a tap handle according to the present disclosure;

FIG. 8 shows a front elevational view of an embodiment of a tap handle according to the present disclosure;

FIG. 9 shows a front elevational view of an embodiment of a tap handle according to the present disclosure;

FIG. 10 shows a side elevational view of the tap handle of FIG. 9.

FIG. 11 shows a front elevational view of an embodiment of a tap handle system according to the present disclosure;

FIG. 12 shows a front elevational view of an embodiment of a tap handle system according to the present disclosure;

FIG. 13 shows a front elevational view of an embodiment of a tap handle system according to the present disclosure; and

FIG. 14 shows a front elevational view of an embodiment of a tap handle system according to the present disclosure;

### DETAILED DESCRIPTION

Before the disclosure is described, it is to be understood that this disclosure is not limited to the particular apparatuses and methods described. It is also to be understood that the terminology used herein is for the purpose of describing particular embodiments only, and is not intended to be limiting, since the scope of the present disclosure will be limited only to the appended claims.

As used in this disclosure and the appended claims, the singular forms “a,” “an” and “the” include plural referents unless the context clearly dictates otherwise. The methods and apparatuses disclosed herein may lack any element that is not specifically disclosed herein. Thus, “comprising,” as used herein, includes “consisting essentially of” and “consisting of.”

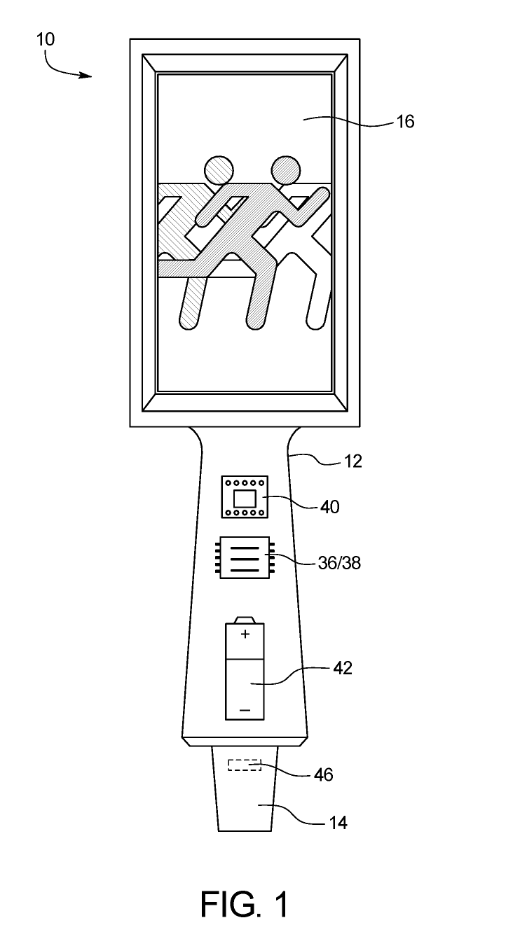

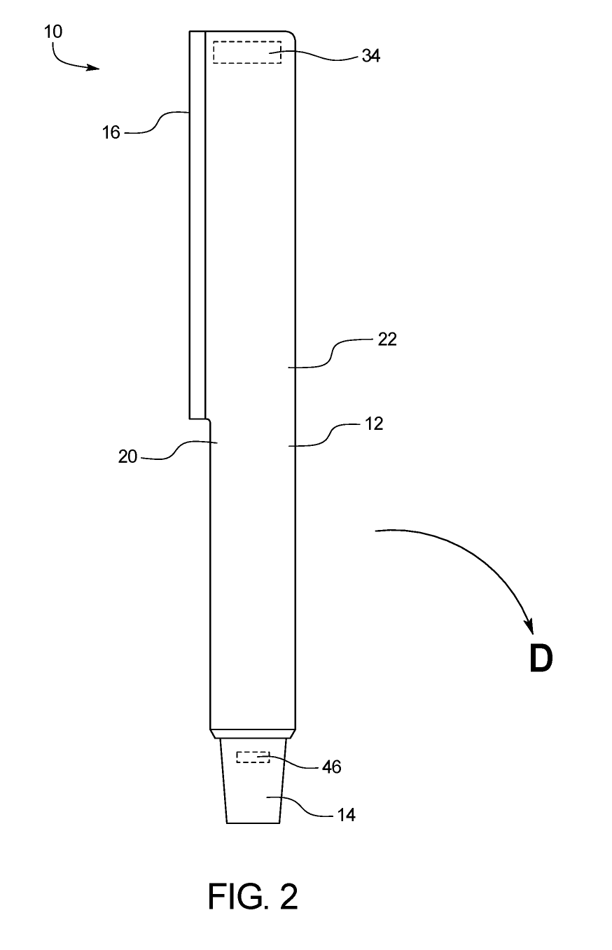

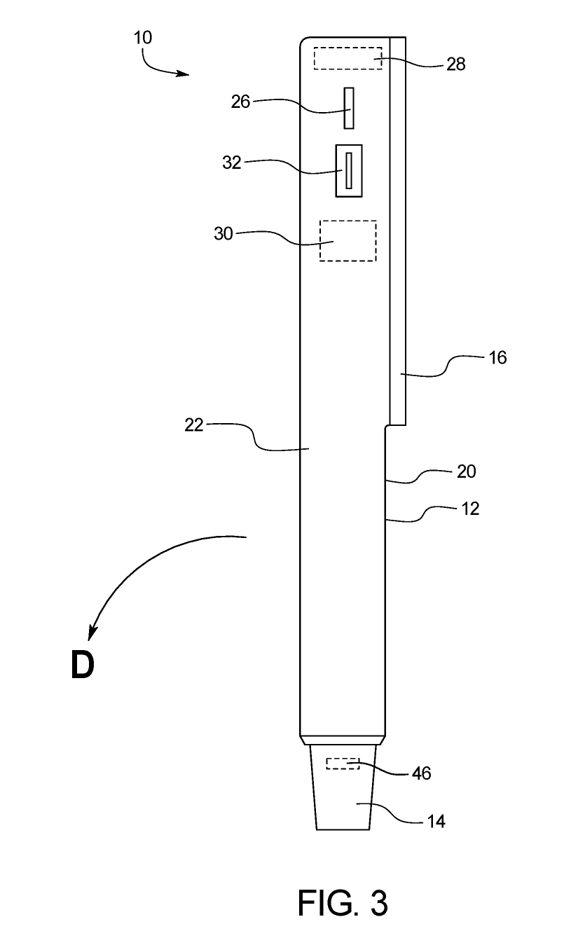

FIGS. 1 to 3 illustrate an example embodiment of a tap handle 10 for a tap handle system according to the present disclosure. Tap handle 10 includes a handle portion 12 that is configured to be gripped by a person and used as a lever, an attachment portion 14 that is configured to attach to a spigot, and a display screen 16 that is attached to the handle portion and configured to display a wide variety of information and images. In use, a user grips handle portion 12 and tilts tap handle 10 sideways, preferably in the direction indicated by arrow D in FIGS. 2 and 3, to open the spigot so that a beverage can be dispensed from the spigot.

Attachment portion 14 attaches tap handle 10 to a spigot. A spigot typically includes a threaded bolt, so in an embodiment an inner surface of attachment portion 14 includes a thread that allows attachment portion 14 to be threaded onto the spigot bolt. Alternatively, an outer surface of attachment portion 14 can be threaded to a spigot, or attachment portion 14 can be attached to a spigot using other attachment mechanisms known in the art.

Once attachment portion 14 has been attached to the spigot, handle portion 12 can be gripped and pulled sideways while attachment portion 14 is attached to the spigot. The sideways motion of handle portion 12 opens the spigot so that a beverage such as beer can be poured from the spigot. The beverage poured from the spigot depends on the type of keg connected to the spigot and can change, for example, based on changing seasons, availability, customer preferences and various other reasons. In the illustrated embodiment, handle portion 12 is pulled in the direction indicated by arrow D because the display screen 16 is intended to be facing out towards a customer when handle portion 12 is at rest.

Display screen 16 can be configured to display a plurality of images to a customer. As used herein, the term “image” can refer to any type of image, for example, still images, moving images, videos, text images and/or the like. In the illustrated embodiment, tap handle 10 includes a single display screen 16 on front side 20 of tap handle 10, which is the side of tap handle 10 that faces towards the customer and away from the person pulling tap handle 10 to pour the beverage from the spigot. In alternative embodiments, display screen 16 can be included on both front side 20 and an opposite rear side 22, or on only rear side 22 to display images or video to the person pulling the tap handle 10 to pour the beverage from the spigot. In another alterative embodiment, display screen 16 can include multiple display screens. Display screen 16 can be, for example, a liquid-crystal display (“LCD”), a light-emitting diode (“LED”) display, an organic light-emitting diode (“OLED”) display, an electronic ink (“eInk”) display, or any other display suitable for displaying images. Those of ordinary skill in the art will recognize other suitable display types. Display screen 16 can also include a touchscreen and/or a non-touchscreen.

The images can be loaded onto display screen 16 in a variety of ways. In the illustrated embodiment, tap handle 10 includes a secure digital (“SD”) card reader 26 that is configured to receive an SD card containing the images to be displayed on display screen 16. Alternatively or additionally, tap handle 10 can include a wireless antenna 28 that receives images wirelessly. Wireless antenna 28 can cause the images to be displayed in real-time as they are wirelessly received, or can cause the images to be stored on a storage device 30 contained within tap handle 10. Wireless antenna 28 can operate, for example, via a wireless internet connection, a Bluetooth connection, a Zigbee connection, a radio-frequency identification (“RFID”) connection, a cellular connection, a beacon connection, a near field communication (“NFC”) connection, or any other wireless connection known to those of ordinary skill in the art. Tap handle 10 can also include a universal serial bus (“USB”) port 32 that is configured to receive a USB storage device containing the images to be displayed on display screen. Those of ordinary skill in the art will recognize other methods and apparatuses for transferring images to tap handle 10 to be displayed on display screen 16.

In the illustrated embodiment, tap handle 10 includes a global positioning system (“GPS”) sensor 34 that transmits the global positioning of tap handle 10. GPS sensor 34 can be used for a variety of tasks. In one embodiment, wireless antenna 28 can transmit readings from GPS sensor 34 to a central controller and can receive images based on the global positioning of tap handle 10. The images can be, for example, targeted to the audience in the specific location of tap handle 10. Alternatively, the reading from GPS sensor 34 can be used to determine images that should not be shown to the audience in the specific location of tap handle 10. In another embodiment, GPS sensor 34 and wireless antenna 28 can be used to transmit data regarding the use of tap handle 10 so that the data can be accumulated and used in the development of new tap handles 10 or in the transmission of new images to tap handle 10. The data transmitted by wireless antenna 28 can include, for example, the volume of beverage poured using tap handle 10, the type of beverage poured using tap handle 10, images on tap handle 10 that received positive or negative feedback from one or more customers, and/or other similar information, which when combined with the GPS data, allows the central controller to determine, for example, what types of beverages and images are popular or unpopular in a particular region.

Tap handle 10 can also include a controller 36 to process the images that are to be loaded onto display screen 16 and to determine when the images should be displayed. In the illustrated embodiment, controller 36 includes a microprocessor 38 located inside of tap handle 10, but the controller 36/microprocessor 38 can also be located at a remote location and wirelessly control display screen 16 via wireless antenna 28. As discussed in more detail below, it is contemplated that a central controller 36 can control a plurality of tap handles 10 at the same time and coordinate the images displayed by the plurality of tap handles 10.

In the illustrated embodiment, tap handle 10 includes a motion device 40, which acts as a trigger for the images displayed by display screen 16. In a preferred embodiment, motion device 40 is an accelerometer that can determine whether tap handle 10 is at rest or is being pulled to dispense a beverage, based on the acceleration of tap handle 10. Motion device 40 can therefore trigger display screen 16 to change a displayed image to a new image whenever tap handle 10 is pulled sideways to dispense a beverage. That is, controller 36 is configured to change the image displayed on display screen 16 each time that motion device 40 indicates that tap handle 10 has been pulled to the side to dispense a beverage. Those of ordinary skill in the art will recognize other motion devices 40 that can be used, for example, a gyroscope that can determine whether the tap handle 10 is at rest or is being pulled, based on the orientation of tap handle 10. In another embodiment, the motion device 40 can be a button that is automatically pressed or released by the motion of tap handle 10 each time tap handle 10 is pulled to dispense a beverage, for example, a button that is located near the spigot and is squeezed by the spigot due to the pulling motion of the tap handle 10. In other embodiments, motion device 40 can include an optical sensor (e.g. an infrared, microwave or ultrasonic sensor), a proximity sensor (e.g., an inductive, capacitive, photoelectric or magnetic sensor), a rheostat and/or a strain gauge. Those of ordinary skill in the art will further recognize other motion devices 40 that can be used to detect that tap handle 10 has been pulled.

Motion device 40 can also be used for other functions. In an embodiment, motion device 40 can be used to determine the approximate volume of beverage in a keg corresponding to the spigot to which the tap handle 10 is attached. Because motion device 40 can determine when tap handle 10 is pulled sideways, as well as the speed and strength of the pull, microprocessor 38 can determine the volume of fluid in the keg based on the time that tap handle 10 is pulled sideways and the flow rate through the spigot. In an embodiment, the flow rate through the spigot is known to the user and can be programmed into tap handle 10. In another embodiment, microprocessor 38 can calibrate itself by calculating the time that it takes to fill up one or more glasses or empty a keg, and then use that calibration for subsequent glasses and kegs. For example, if it takes 25 seconds to fill up a 0.5 L glass, microprocessor 38 can determine that the spigot pours the beverage at approximately 20 mL/sec. The microprocessor can thereafter determine how much beverage is poured from the spigot based on the approximate time that the spigot is pulled. For example, if a keg holds 50 liters, microprocessor 38 can determine that the keg will be empty after approximately 72 minutes of pull time. Tap handle 10 can therefore alert the server or bartender, via display screen 16, wireless antenna 28 or another mechanism, the approximate time that the keg will need to be changed. Tap handle 10 can also notify the server or bartender of the approximate volume of fluid left in the keg at any given time. It should be understood by those ordinary skill in the art that other mechanisms can be included to measure fluid flow, for example, a flow meter (e.g., a differential pressure, turbine, vortex or electromagnetic flow meter) or an optical sensor (e.g., an infrared, microwave or ultrasonic sensor).

In an alternative embodiment, motion device 40 can be used as a trigger for other functions, for example, to trigger a sign on a wall or to light a sign, or to trigger another light. Those of ordinary skill in the art will further recognize other ways to use motion device 40 as a trigger.

In the illustrated embodiment, the SD card reader 26 and USB port 32 are located on the side of tap handle 10 next to display screen 16 for easy access. The wireless antenna 28, storage device 30, GPS sensor 34, microprocessor 38 and motion device 40 are located inside of tap handle 10. Those of ordinary skill will understand that the location of each of these components can change. Tap handle 10 can also include one or more panels covering one or more of SD card reader 26, wireless antenna 28, storage device 30, USB port 32, GPS sensor 34, microprocessor 38 and motion device 40, which allow a user to access each of these components by removing a panel.

In the illustrated embodiment, tap handle 10 includes a power source 42 to power one or more of display screen 16, SD card reader 26, wireless antenna 28, storage device 30, USB port 32, GPS sensor 34, microprocessor 38, motion device 40 and/or any other electronics associated with tap handle 10. Power source 42 can be a rechargeable battery, for example, a low voltage DC power battery up to 45 volts. Alternatively, power source 42 can be charged, or power can be provided to the components of tap handle 10, through USB port 32, an AC to DC wall transformer, direct AC line voltage, and/or through an inductive coupling. Those of ordinary skill in the art will recognize other power sources 42 that can be used to power the electronics associated with tap handle 10.

In the illustrated embodiment, display screen 16 faces towards the customer and away from the server or bartender dispensing the beverage. Alternatively, tap handle 10 can be reversed so that display screen 16 faces the server or bartender and provides the server or bartender with information related to the beverage poured from the corresponding spigot. For example, display screen 16 can provide the server or bartender with the name of the beverage in the keg attached to the spigot, the price of the beverage, and/or the amount of beverage left in the keg before the keg needs to be changed. The same information can also be provided to the customer if display screen 16 is facing the customer.

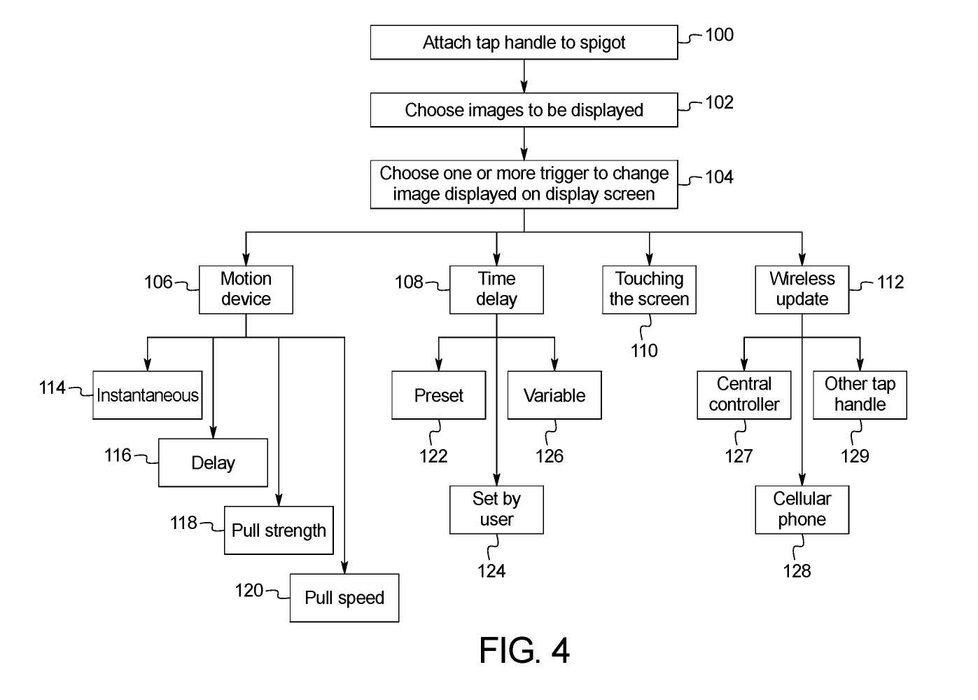

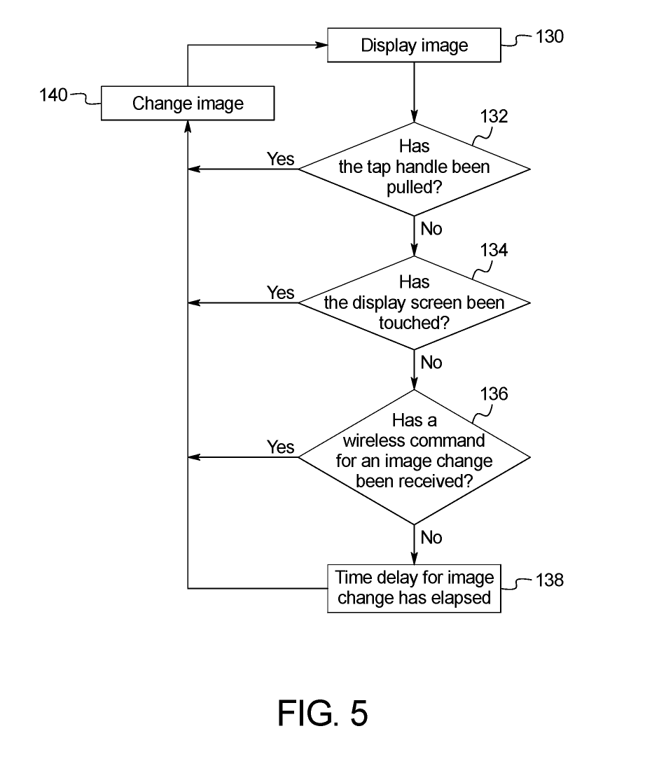

Use of tap handle 10 will now be explained by reference to FIGS. 4 and 5. As discussed above, tap handle 10 must be pulled sideways to dispense a beverage from the corresponding spigot. In a preferred embodiment, controller 36 is configured to change the image displayed on display screen each time that motion device 40 indicates that tap handle 10 has been pulled to the side to dispense a beverage. The image change on display screen 16 can be instantaneous as tap handle 10 is pulled to the side, or can occur on a timed delay after tap handle 10 has been pulled to the side and returned to its stationary position. The change on the display can also differ based on a reading from motion device 40 indicating how hard or soft tap handle 10 is pulled, or based on a reading from motion device 40 indicating the amount tap handle 10 is pulled. The order of images can be predetermined by controller 36, or can be randomly determined as tap handle 10 is pulled to the side.

FIG. 4 is a flow chart showing how tap handle 10 can be programmed to display various images using different triggers. Before describing the programming process, it should be understood that a user can program tap handle 10 in a variety of ways. For example, display screen 16 can be a touch screen, and a user can program tap handle 10 by touching display screen 16 to indicate what types of images should be displayed. In an embodiment, tap handle 10 can include two display screens: (i) a touch display screen 16a on the rear side 22 of handle portion 12 facing the bartender; and (ii) another display screen 16b on the front side 20 of handle portion 12 facing the customer. The bartender can program tap handle 10 using display screen 16a on the rear side 22, and the other display screen 16b on the front side 20 can then be used to display images to the customer based on the programming into display screen 16a. Alternatively, all programming can be done using the same display screen 16, or tap handle 10 can be preprogrammed so that no programming is necessary once attachment portion 14 is attached to a spigot.

In an alternative embodiment, tap handle 10 can be made with only a touch display screen 16 on one side, but handle portion 12 can be made to swivel 360° so that the display screen 16 can be facing the bartender while the display screen 16 is being programmed, and can then be turned to face the customer to display the images programmed by the bartender. One example of a swiveling mechanism that can be used with a tap handle 10 according to the present disclosure is described in U.S. application Ser. No. 14/640,294, entitled “Adjustment Mechanism for a Beverage Tap Handle”, the disclosure of which is hereby incorporated by reference herein.

Further, although the above embodiments discuss programming the image change settings directly into tap handle 10, other embodiments are contemplated. Tap handle 10 can also be programmed via a wireless signal received from a remote controller 36 such as a computer or cellular phone, or via a wireless signal from another tap handle 10 which includes settings already programmed for the other tap handle 10. In one embodiment, a user can perform all of the programming using a cellular phone application that downloads the programmed settings to the tap handle 10 via wireless antenna 28. That is, a user can download an application to his or her cellular phone which allows the user to create settings for tap handle 10 and/or send images to tap handle 10 to be displayed on display screen 16. In another embodiment, the programming can be performed on a remote computer and downloaded to tap handle 10 via wireless antenna 28, SD card reader 26, USB port 32 and/or another information downloading mechanism. Those of ordinary skill will recognize other ways to program tap handle 10.

Beginning at step 100 of FIG. 4, use of tap handle 10 can start with tap handle 10 being attached to the spigot. As discussed above, tap handle 10 can be screwed onto a spigot or attached by another attachment mechanism. In an embodiment, tap handle 10 includes a spigot sensor 46 that powers the components of tap handle 10 when it is determined that tap handle 10 has been attached to the spigot. Spigot sensor 46 can be, for example, a button located in attachment portion 12 that is pressed by the spigot as attachment portion 12 is screwed onto the spigot. Although FIG. 4 shows tap handle 10 being attached to the spigot before the image programming begins, those of ordinary skill in the art will further understand that tap handle 10 can also be programmed before being attached to the spigot.

At step 102, the user programs tap handle 10 by choosing the images to be displayed on display screen 16. The images can be, for example, still images such as picture advertisements, or moving video images such as video advertisements. The user can choose from a variety of settings when choosing the images to be displayed on display screen 16. The user can choose, for example, where the displayed images will be retrieved from (e.g., SD card reader 26, wireless antenna 28, storage device 30, and/or USB port 32). The user can also choose, for example, the particular images that the user wishes to be displayed on the display screen. The user can choose a single image to be displayed, or the user can choose a set of images to be displayed at different intervals. In an embodiment, the user can program display screen 16 to display images corresponding to advertisements and/or information related to the keg that is attached to the spigot of tap handle 10, which can indicate to the customer what type of beverage is available on tap. In other embodiments, the user can program display screen 16 to display images corresponding to advertisements and/or information relating to the bar or restaurant dispensing the beverage, other local establishments, or information of general interest to the bar or restaurant's customer base. Those of ordinary skill in the art will recognize other ways to use display screen 16.

At step 104, if a set of images are to be displayed, the user can then chooses the trigger that will cause a current image to be changed to a subsequent image on display screen 16. The trigger can be, for example, based on one or more of (i) a signal from motion device 40 indicating that tap handle 10 has been pulled to the side (step 106), (ii) a fixed or variable time delay (step 108), (iii) an action such as touching display screen 16 (step 110), and/or (iv) a signal received by wireless antenna 28 (step 112). In an example embodiment combining more than one of the above triggers, the image can change (i) every time motion device 40 indicates that tap handle has been pulled to the side; (ii) after a fixed amount of time if the tap handle 10 has not been pulled to the side during the fixed amount of time; and/or (iii) every time the screen is touched regardless of how long it has been since the image was last changed.

At step 106, the user has selected that the image on display screen 16 should change every time motion device 40 indicates that tap handle 10 has been pulled to the side. The user can then further customize tap handle 10 so that the image change is (i) instantaneous with a signal from motion device 40 (step 114), (ii) based on a time delay after a signal from motion device 40 (step 116), (iii) based on how hard or soft tap handle 10 is pulled (step 118), and/or (iv) based on the amount tap handle 10 is tilted (step 120). Those of ordinary skill in the art will recognize that the motion device 40 can also be used in other ways.

At step 108, the user has selected that the image on display screen 16 should change based on a time delay. The time delay can be a preset time delay (step 122), a time delay set by the user using display screen 16 (step 124), and/or a variable time delay (step 126). The time delay can also be used in combination with the trigger from motion device 40 so that the image on display screen 16 changes after a certain amount of time if tap handle 10 is not pulled to the side to dispense a beverage. Such a setting can be advantageous, for example, to catch the attention of customers and direct the customers to a certain type of beverage that has not been ordered for a certain amount of time. In an embodiment, the time delay setting can be used to set a sale price or other special offer for a beverage that has not been dispensed for a certain amount of time.

At step 110, the user has selected that the image on display screen 16 should be changed each time the user touches the screen. This selection can be advantageous, for example, to allow customers to interact with the display screen to view images or advertisements of particular interest, or to change images that are not of interest. The touch change can also be used in combination with the trigger from motion device 40 and the time delay, so that the image changes when touched by a user regardless of the other triggers or image change settings set by the user.

At step 112, the user has selected that the image should change based on a wireless update. That is, a remote controller 36 wirelessly communicates with wireless antenna 28 and determines when the image should be changed and/or what the new image should be. The remote controller 36 can include, for example, a central controller (step 127), a cellular phone communicating with tap handle 10 through a downloaded application (step 128), and/or another tap handle 10 communicating through its own wireless antenna (step 129). In one embodiment, the image displayed by display screen 16 can change each time a new image is received by wireless antenna 28. In another embodiment, the plurality of images are stored by storage device 30 and are changed when wireless antenna 28 receives a signal to change the image on display screen 16. The wireless update embodiments are useful, for example, to provide customers with real-time images, and/or to coordinate images or image changes between a plurality of tap handles 10 and/or based on GPS signals from one or more tap handles 10. The wireless update embodiments can also be used in combination with the trigger from motion device 40, the time delay and the touch trigger, so that images can be changed based on signals received by wireless antenna 28 regardless of the other triggers or image change settings set by the user.

In addition the above features, tap handle 10 can also be used to collect, store and transmit usage data to a central controller so that the usage data can be used to determine the images that are displayed on tap handle 10. In an embodiment, the usage data can include the volume of beverage poured using tap handle 10, the type of beverage poured using tap handle 10, other pour data related to the beverage(s) poured using tap handle 10, images on tap handle 10 that received positive or negative feedback from one or more customers, GPS signals from tap handle 10, information related to push advertising, and/or any other similar data and information. Tap handle 10 can also be used to collect data from cellular phones that allow data to be transmitted to wireless antenna 28, so that data from the cellular phones can be gathered and used to display images on display screen 16 that target the audience viewing display screen 16.

FIG. 5 is a flow chart showing an example embodiment of the logic that can be used by microprocessor 38 if the user selects each of the triggers 106, 108, 110, 112 in FIG. 4. At step 130, an image is displayed on display screen 16. The image can be a first image in a set of images or a subsequent image. At step 132, the microprocessor 38 first determines whether tap handle 10 has been pulled sideways based on a signal from motion detector 40. If tap handle 10 has been pulled sideways, microprocessor 38 proceeds to step 140 and changes the image on the display. Microprocessor 38 then loops back to step 130 with the new image. If tap handle 10 has not been pulled sideways, then microprocessor moves on to step 134 and determines whether display screen 16 has been touched by a user. If display screen 16 has been touched by a user, microprocessor 38 proceeds to step 140 and changes the image on the display. Microprocessor 38 then loops back to step 130 with the new image. If display screen 16 has not been touched by a user, then microprocessor moves on to step 136 and determines whether a wireless command to change the image has been received by wireless antenna 28. If a wireless command has been received, microprocessor 38 proceeds to step 140 and changes the image on the display. Microprocessor 38 then loops back to step 130 with the new image. If a wireless command has not been received, then microprocessor 38 moves on to step 138. At step 138, microprocessor determines that the time delay has elapsed since the image display began, without any of steps 132, 134 or 136 causing the image to change. Since microprocessor 38 is programmed to change the image after a time delay if the image is not changed for another reason, microprocessor 38 proceeds to step 140 and changes the image on the display. Microprocessor 38 then loops back to step 130 with the new image.

It should be understood by those of ordinary skill in the art that steps 132, 134, 136 and 138 can be performed in any order, and are simply shown in a particular order in FIG. 5 for illustrative purposes. In a preferred embodiment, microprocessor 38 performs each of steps 132, 134, 136 and 138 simultaneously, so that the image is instantaneously changed when any of steps 132, 134, 136 and 138 occur. If none of steps 132, 134 and 136 occur during the set time delay, then microprocessor changes the image when the time delay has elapsed at step 138. It should further be understood by those of ordinary skill in the art that one or more steps can be removed from FIG. 5, or one or more steps can be added with different triggers for changing the image on display screen 16.

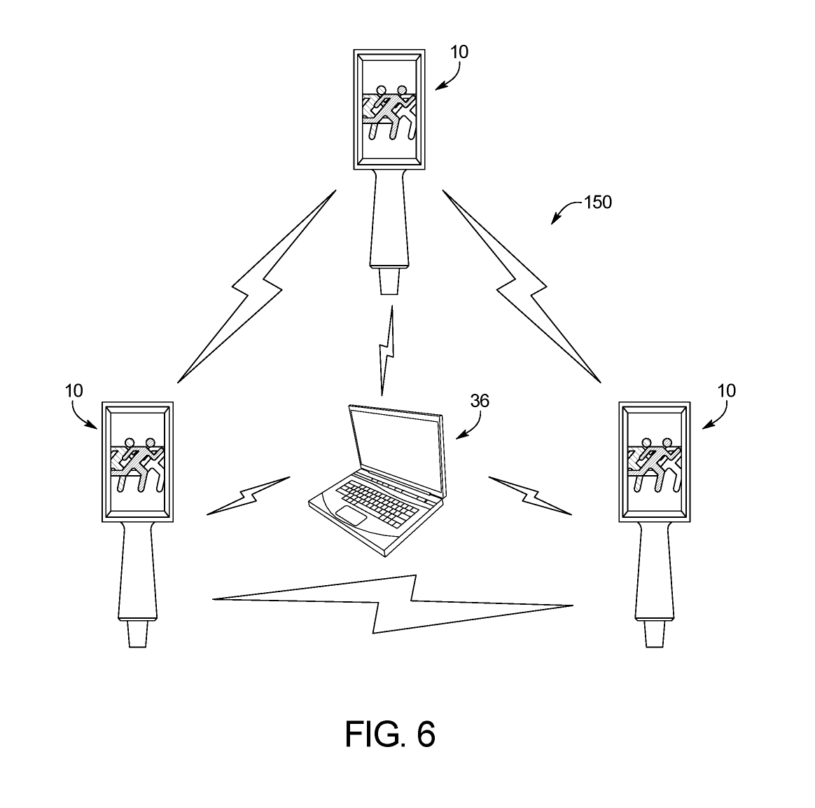

FIG. 6 shows a system or network 150 of tap handles 10 that are configured to communicate with each other through a central controller 36 and/or directly through their respective wireless antennas 28. In an embodiment, the central controller 36 can coordinate images displayed by the plurality of tap handles 10. In another embodiment, the tap handles 10 can each include a microprocessor that allows the tap handles 10 to coordinate with each other without the need for a central controller 36. The tap handles 10 can be located in the same location or in different locations.

In the illustrated embodiment, central controller 36 includes a personal computer, but those of ordinary skill in the art will recognize other controllers 36 that can coordinate the images on multiple tap handles 10 at the same time. For example, cellular phones, tablets and other electronic devices can be used to communicate with and control a plurality of tap handles 10. In the illustrated embodiment, each of the plurality of tap handles 10 can communicate with each other of the plurality of tap handles 10 and with the central controller 36. Central controller 36 can therefore be used to set up the plurality of tap handles 10 and thereafter control the plurality of tap handles 10, or central controller 36 can be used to set up the plurality of tap handles 10 and thereafter allow the plurality of tap handles 10 to wirelessly communicate with each other without communicating with central controller 36. Alternatively, the plurality of tap handles 10 can be set up and controlled without the need for central controller 36.

In an embodiment, the images shown on the plurality of tap handles 10 can be coordinated so that each of the plurality of tap handles 10 shows the same or a similar image at the same time. Such coordination can be useful, for example, when the tap handles 10 are all located in the same vicinity at a bar or restaurant, or when the tap handles 10 are located in different locations but the display screens 16 are used to run a common promotion. The tap handles 10 can be coordinated, for example, so that only one tap handle 10 shows a video at a time, while the other tap handles 10 show images that correspond to the video. In an embodiment, one tap handle can signal to another tap handle when an image should be displayed by the other tap handle. For example, when a video finishes on one tap handle 10, that tap handle 10 can signal to the next tap handle 10 that a new video should begin playing on the next tap handle 10. Those of ordinary skill in the art will recognize numerous advantages of having multiple tap handles 10 in wireless communication with each other or a central controller 36.

The plurality of tap handles 10 shown in FIG. 6 can also be used to gather usage data and communicate the data to central controller 36 so that central controller 36 can collect the usage data and use the usage data to select new imagery to be shown on one or more of the plurality of tap handles 10. For example, central controller 36 can determine that a particular image is popular in one location and direct tap handles 10 in other locations to display the same image. Likewise, central controller 36 can determine that a particular image is unpopular in one location and direct tap handles 10 in other locations to stop showing the same image.

Having the plurality of tap handles 10 in wireless communication with each other, with or without a central controller 36 also has several other advantages. For example, images can be loaded into one tap handle 10 with an SD or USB card, and then the images can be wirelessly transmitted to the other tap handles 10 without the user having to load the images on the rest of the plurality of tap handles 10. Likewise, the settings on one tap handle 10 can be wirelessly transmitted to other tap handles 10 without the user having to individually program each tap handle 10. In an embodiment, one tap handle 10 can be designated as a master tap handle, and with the push of a button the master tap handle can push its settings to each of the connected tap handles 10, which greatly simplifies the time and effort to program multiple tap handles 10. In another embodiment, one tap handle 10 can provide the trigger for one or more other tap handles 10 to change a displayed image to a new image.

Central controller 36 can also be used to determine when kegs need to be changed. In an embodiment, each tap handle 10 can transmit data to central controller 36 indicating the volume of beverage left in the kegs attached to the spigots. Central controller 36 can then be used to coordinate and optimize keg changes.

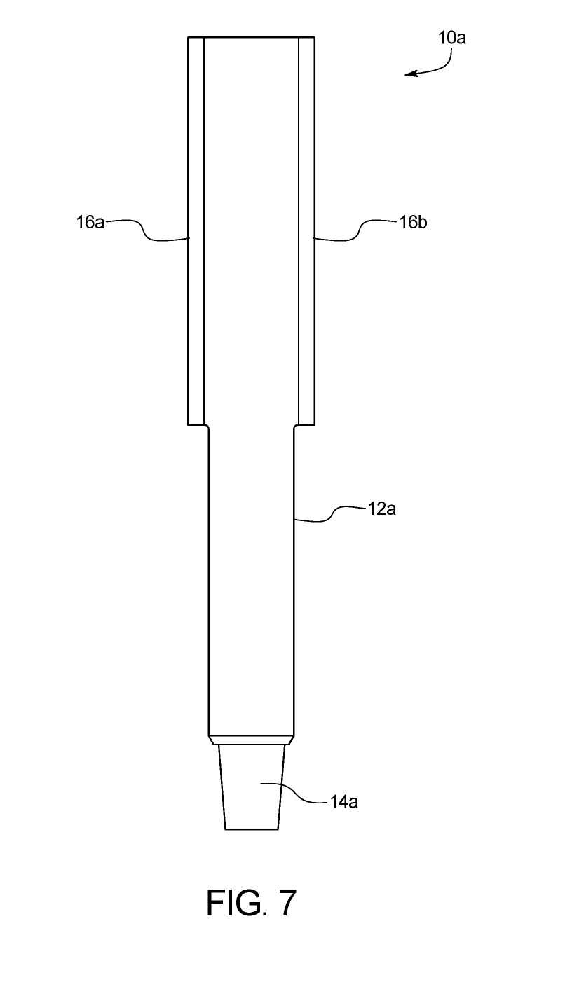

FIG. 7 shows an alternative embodiment of a tap handle 10a according to the present disclosure. Like tap handle 10, tap handle 10a includes a handle portion 12a that is configured to be gripped by a person and used as a lever, and an attachment portion 14a that is configured to attach to a spigot. It should be understood by those of ordinary skill in the art that any of the other elements of tap handle 10 discussed above can also be incorporated into tap handle 10a.

Tap handle 10a differs from tap handle 10 in that tap handle 10a includes two display screens 16a and 16b. Display screen 16a is configured to be facing the bartender or server when tap handle 16a is attached to a spigot, while display screen 16b is configured to be facing the customer. The multiple display screens 16a, 16b provide several advantages. In one embodiment, display screen 16a can be used by the bartender or server to program tap handle 10a, and display screen 16b can be used to display the programmed images. Alternatively, display screen 16a can be used to notify the server of certain information regarding the beverage poured out of the corresponding spigot, for example, the name/type of the beverage in the keg attached to the spigot, the price of the beverage, and/or the amount of beverage left in the keg before the keg needs to be changed. As set forth above, microprocessor 38 can use motion device 40 to calculate the volume of beverage in the keg, and notify the server or bartender of the approximate volume left in the keg and/or alert the server or bartender when the keg needs to be changed. While display screen 16a gives the server or bartender information regarding the beverage served, display screen 16b can be used to display advertisements to the customer.

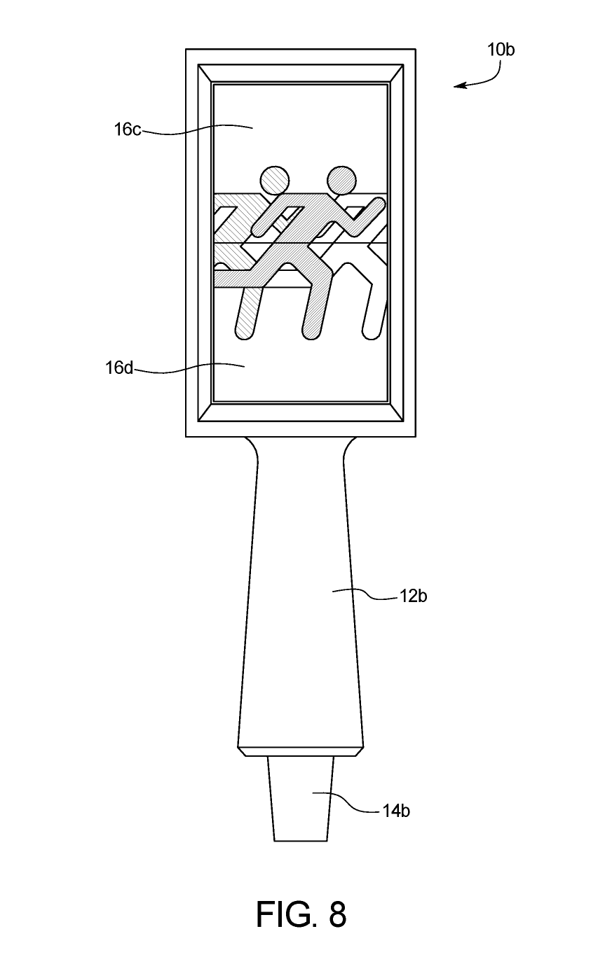

FIG. 8 shows an alternative embodiment of a tap handle 10b according to the present disclosure. Like tap handle 10, tap handle 10b includes a handle portion 12b that is configured to be gripped by a person and used as a lever, and an attachment portion 14b that is configured to attach to a spigot. It should be understood by those of ordinary skill in the art that any of the other elements of tap handle 10 discussed above can also be incorporated into tap handle 10b.

Tap handle 10b differs from tap handle 10 in that tap handle 10b includes two display screens 16c and 16d on the same side of handle portion 12b. In the illustrated embodiment, display screens 16c and 16d are cooperating with each other to display the same image. Alternatively, display screens 16c and 16d can be used to show different images. For example, display screen 16c can display the name and type of beverage being poured by the spigot, while display screen 16d can display a video advertisement for the beverage being poured by the spigot. Alternatively, display screens 16c and 16d can be used to display unrelated images. Those of ordinary skill in the art will recognize that any number of display screens can be included on the front, rear and/or sides of handle portion 12b.

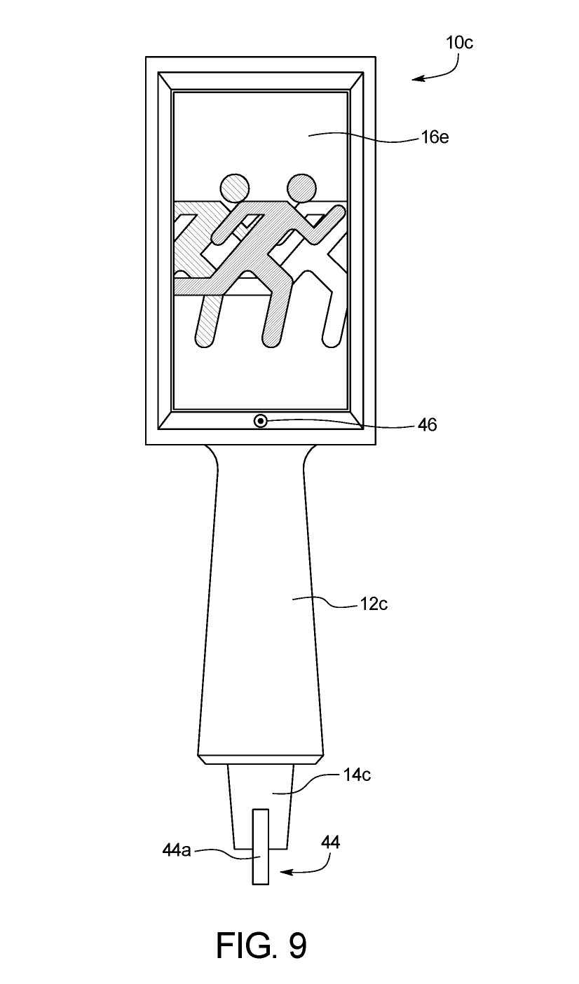

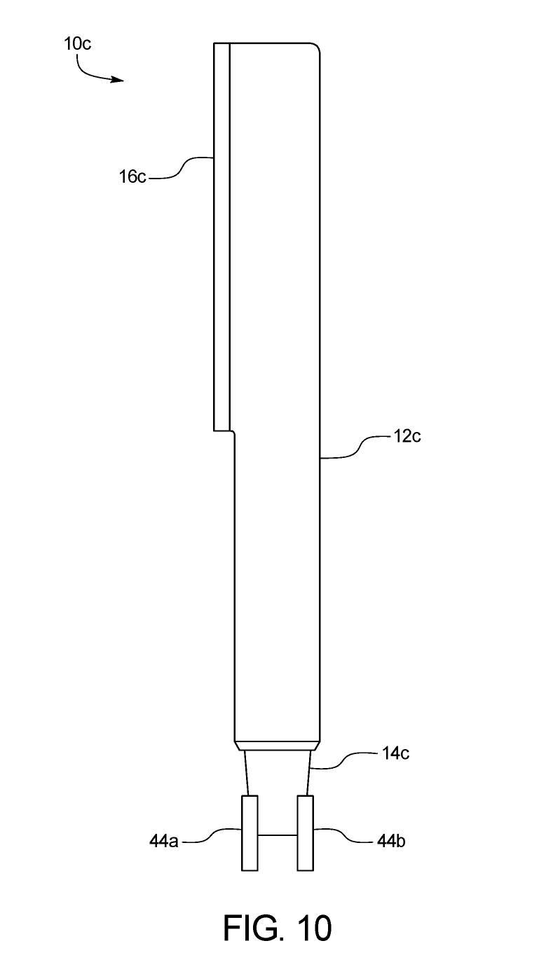

FIGS. 9 and 10 show an alternative embodiment of a tap handle 10c according to the present disclosure. Like tap handle 10, tap handle 10c includes a handle portion 12c that is configured to be gripped by a person and used as a lever, and an attachment portion 14c that is configured to attach to a spigot. It should be understood by those of ordinary skill in the art that any of the other elements of tap handle 10 discussed above can also be incorporated into tap handle 10c.

Tap handle 10c differs from tap handle 10 in that tap handle 10c includes a security mechanism 44 that prevents tap handle 10c from being pulled sideways to dispense a beverage from the spigot. In the illustrated embodiment, security mechanism 44 includes two bars 44a and 44b protruding downwardly from attachment portion 14c. When exposed, one or both of the bars 44a, 44b prevents attachment portion 14c of tap handle 10c from pivoting on the spigot. The bars 44a, 44b can be removed, for example, by typing a code into display screen 16e to unlock tap handle 10c. Once unlocked, the bars 44a, 44b are withdrawn into attachment portion 14c, and tap handle 10c can be used to pour a beverage. Those of ordinary skill in the art will understand that other security measures can be implemented, which can be locked or unlocked using display screen 16e.

Tap handle 10c can also include a personal recognition sensor 46. The personal recognition sensor 46 can be, for example, a retinal sensor, a facial sensor a fingerprint sensor and/or the like. In an embodiment, personal settings for tap handle 10c can be stored in a storage device within tap handle 10c, and personal recognition sensor 46 can be used to implement the personal settings without the need for additional programming, which can save time for the user each time a tap handle needs to be programmed. Alternatively, personal recognition sensor 46 can be used to turn on display screen 16e, lock or unlock tap handle 10c for use, and/or to lock or unlock a security mechanism such as security mechanism 44 discussed above. Those of ordinary skill in the art will recognize other uses for personal recognition sensor 46.

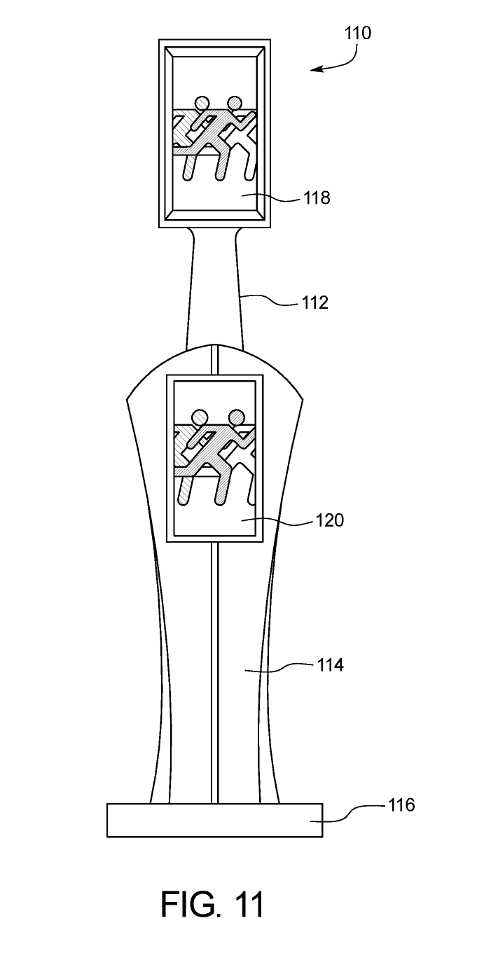

In the above embodiments, the display screens are located directly on the tap handles. It should be understood, however, that the display screens can also be placed in other locations in addition to or as an alternative to being placed on the tap handle. FIGS. 11 to 14, for example, illustrate embodiments in which the display screens are attached to towers on a bar. The tower is attached to the bar and includes one or more spigots for attachment to one or more tap handles. It should be understood by those of ordinary skill in the art that any of the elements of the tap handles disclosed above can also be included on the tap handles and/or towers shown in FIGS. 11 to 14.

FIG. 11 shows an embodiment of a tap handle system 110 including a tap handle 112 and a tower 114. In an embodiment, the tower 114 is attached to a bar 116 and includes a spigot (not shown) for attachment to the tap handle 112. In the illustrated embodiment, tap handle 112 includes a first display screen 118, and tower 114 includes a second display screen 120. First display screen 118 and/or second display screen 120 can be triggered using any of the triggers discussed above, for example, a motion sensor that indicates when tap handle 112 has been pulled to dispense a beverage. The images displayed on first display screen 118 and second display screen 120 can be the same or different. In an embodiment, one of the triggers described above triggers both first display screen 118 and second display screen 120 to change an image at the same time. Alternatively, first display screen 118 and second display screen 120 can alternate changing an image each time a trigger is indicated. Those of ordinary skill in the art will further recognize other uses for first display screen 118 and second display screen 120. It should be understood that tap handle 112 and/or tower 114 can include any of the elements discussed above for tap handle 10.

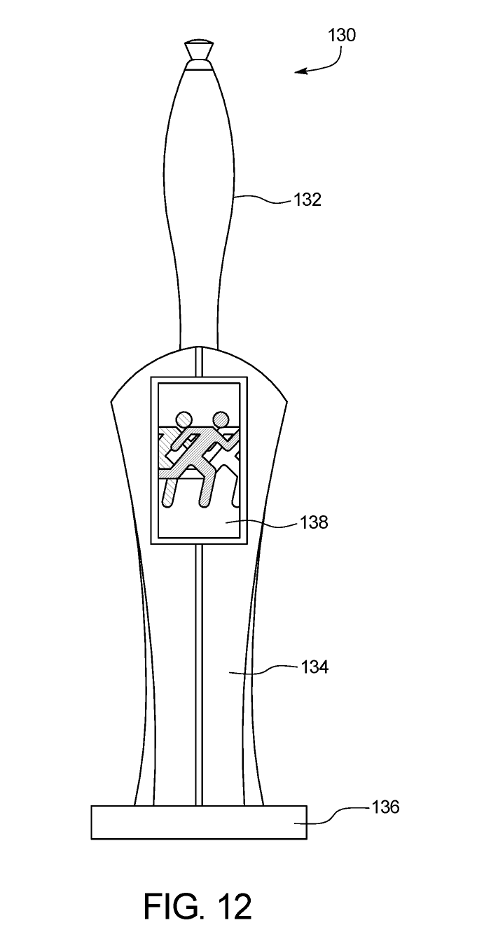

FIG. 12 shows an embodiment of a tap handle system 130 including a tap handle 132 and a tower 134. In an embodiment, the tower 134 is attached to a bar 136 and includes a spigot (not shown) for attachment to the tap handle 132. In the illustrated embodiment, tower 134 includes a display screen 138 that functions in the same way as display screen 16 discussed above. The main difference between tap handle 10 above and the embodiment of FIG. 12 is that display screen 138 has been placed on tower 134 instead of on tap handle 132. Tap handle 132 and display screen 138 can function the same way as tap handle 10 and display screen 16 above in all other respects.

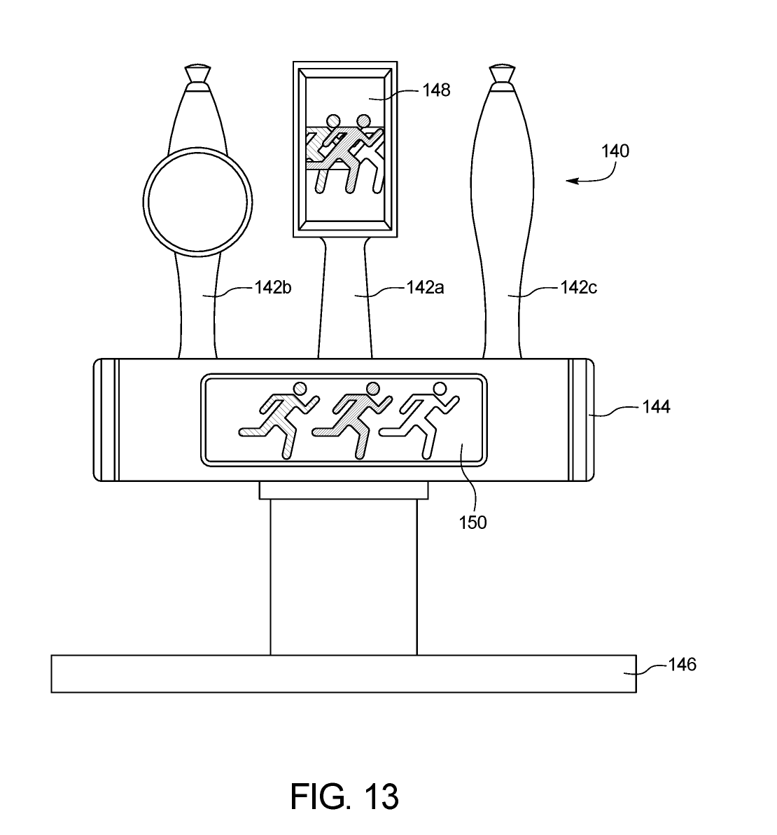

FIG. 13 shows an embodiment of a tap handle system 140 including a plurality of tap handles 142a, 142b, 142c and a tower 144. In an embodiment, the tower 144 is attached to a bar 146 and includes a plurality of spigots (not shown) each configured for attachment to a tap handle 142a, 142b, 142c. In the illustrated embodiment, tap handle 142a includes a first display screen 148, and tower 144 includes a second display screen 150. First display screen 148 and/or second display screen 150 can be triggered using any of the triggers discussed above, for example, a motion sensor that indicates when one or more of tap handles 142a, 142b, 142c have been pulled to dispense a beverage. The images displayed on first display screen 148 and second display screen 150 can be the same or different. In an embodiment, one of the triggers described above triggers both first display screen 148 and second display screen 150 to change an image at the same time. Alternatively, first display screen 148 and second display screen 150 can alternate changing an image each time a trigger is indicated.

Although only tap handle 142a is shown with a first display screen 148 in FIG. 13, it should be understood that tap handle 142b and/or tap handle 142c can also include first display screens 148. In an embodiment, the first display screens 148 on the tap handles 142a, 142b, 142c can display one or more images related to the beverage poured from each tap handle 142a, 142b, 142c, and the second display screen 150 can display general advertising information or other information of interest to the customer. In another embodiment, each of the tap handles 142a, 142b, 142c can include a motion sensor and the image on second display screen 150 can change each time a tap handle 142a, 142b, 142c is pulled. Those of ordinary skill in the art will recognize other ways to use the triggers discussed above with first display screen 148 and second display screen 150. It should be understood that tap handles 142a, 142b, 142c and/or tower 144 can include any of the elements discussed above for tap handle 10.

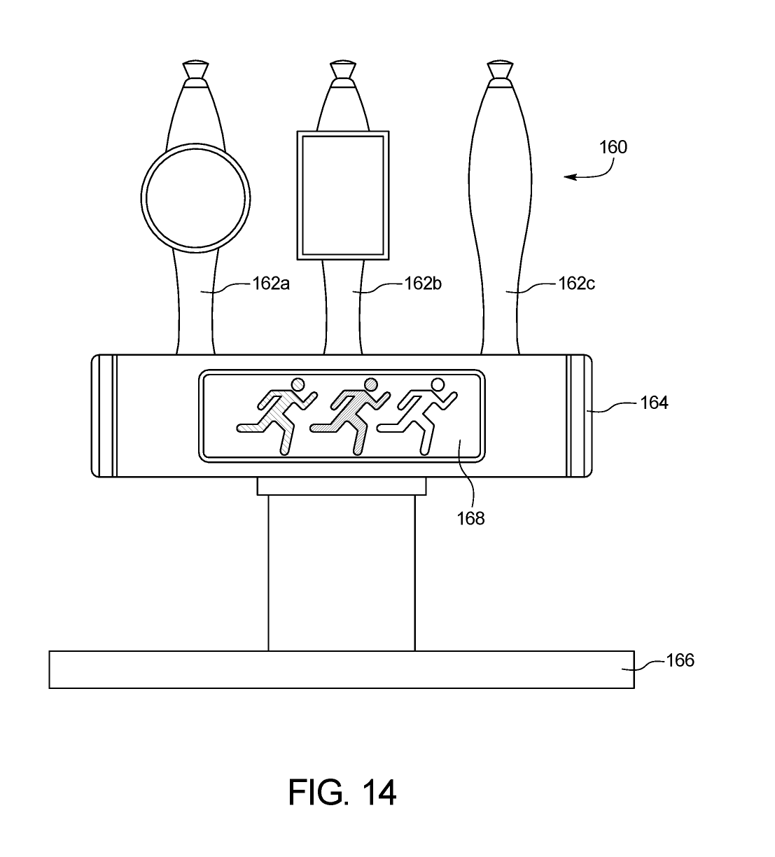

FIG. 14 shows an embodiment of a tap handle system 160 including a plurality of tap handles 162a, 162b, 162c and a tower 164. In an embodiment, the tower 164 is attached to a bar 166 and includes a plurality of spigots (not shown) each configured for attachment to a tap handle 162a, 162b, 162c. In the illustrated embodiment, tower 164 includes a display screen 168 that functions in the same way as display screen 16 discussed above. The main difference between tap handle 10 above and the embodiment of FIG. 14 is that display screen 168 has been placed on tower 164 instead of on one or more of tap handles 162a, 162b, 162c.

Tap handles 162a, 162b, 162c and display screen 168 can function the same way as tap handle 10 and display screen 16 above in all other respects. In an embodiment, each of the tap handles 162a, 162b, 162c can include a motion sensor and the image on display screen 168 can change each time a tap handle 162a, 162b, 162c is pulled. In an alternative embodiment, the image on display screen 168 can change each time display screen 168 is touched by a user. Those of ordinary skill in the art will recognize other ways to use display screen 168 based on the disclosure herein.

Although the figures herein show the display screen on the tap handle and/or tower, it should further be understood by those of ordinary skill in the art that the display screen can be located remotely from the tap handle and tower and communicate with the tap handle and/or tower wirelessly or via a wired connection. For example, a display screen could be located on the wall of a bar or restaurant and function as discussed above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### Additional Aspects of the Present Disclosure

Aspects of the subject matter described herein may be useful alone or in combination with any one or more of the other aspect described herein. Without limiting the foregoing description, in a first aspect of the present disclosure, a beverage tap handle system comprises a handle portion that can be pulled to dispense a beverage from a spigot, an attachment portion that attaches the handle portion to the spigot, a display screen configured to display a plurality of images, and a controller that controls the display screen to change an image displayed on the display screen to a new image, the controller programmed to: (i) change the displayed image to the new image when the handle portion is pulled to dispense the beverage; and/or (ii) change the displayed image to the new image after the displayed image has been displayed for a predetermined amount of time.

In accordance with a second aspect of the present disclosure, which may be used in combination with any other aspect or combination of aspects listed herein, the beverage tap handle system includes a tower, wherein the spigot attaches the handle portion to the tower, and the display screen is located on the tower.

In accordance with a third aspect of the present disclosure, which may be used in combination with any other aspect or combination of aspects listed herein, the display screen is a first display screen, and which includes a second display screen located on the handle portion.

In accordance with a fourth aspect of the present disclosure, which may be used in combination with any other aspect or combination of aspects listed herein, the display screen is located on the handle portion.

In accordance with a fifth aspect of the present disclosure, which may be used in combination with any other aspect or combination of aspects listed herein, the beverage tap handle system includes a motion device that triggers the controller to change the displayed image to the new image when the handle portion is pulled to dispense the beverage.

In accordance with a sixth aspect of the present disclosure, which may be used in combination with any other aspect or combination of aspects listed herein, the beverage tap handle system includes a wireless antenna, and wherein the controller is further programmed to change the displayed image to the new image when a signal is received by the wireless antenna.

In accordance with a seventh aspect of the present disclosure, which may be used in combination with any other aspect or combination of aspects listed herein, the display screen includes a touch screen, and wherein the controller is further programmed to change the displayed image to the new image when the touch screen is touched.

In accordance with a eighth aspect of the present disclosure, which may be used in combination with any other aspect or combination of aspects listed herein, the beverage tap handle system includes a storage device that stores the plurality of images.

In accordance with a ninth aspect of the present disclosure, which may be used in combination with any other aspect or combination of aspects listed herein, the plurality of images includes at least one of: (i) a still image; (ii) a moving image; (iii) a video; and (iv) a text image.

In accordance with a tenth aspect of the present disclosure, which may be used in combination with any other aspect or combination of aspects listed herein, the beverage tap handle system includes a global positioning system (“GPS”) sensor, and wherein the new image is based on a reading from the GPS sensor.

In accordance with an eleventh aspect of the present disclosure, which may be used in combination with any other aspect or combination of aspects listed herein, the handle portion is configured to swivel about the attachment portion so that the display screen can be oriented in a plurality of directions.

In accordance with a twelfth aspect of the present disclosure, which may be used in combination with any other aspect or combination of aspects listed herein, the new image is a predetermined image.

In accordance with a thirteenth aspect of the present disclosure, which may be used in combination with any other aspect or combination of aspects listed herein, a beverage tap handle system comprises a handle portion that can be pulled to dispense a beverage from a spigot, an attachment portion that attaches the handle portion to the spigot, a display screen configured to display a plurality of images, and a motion device that triggers the display screen to change an image displayed on the display screen to a new image when the handle portion is pulled to dispense the beverage.

In accordance with a fourteenth aspect of the present disclosure, which may be used in combination with any other aspect or combination of aspects listed herein, the beverage tap handle system includes a tower, wherein the spigot attaches the handle portion to the tower, and the display screen is located on the tower.

In accordance with a fifteenth aspect of the present disclosure, which may be used in combination with any other aspect or combination of aspects listed herein, the display screen is a first display screen, and which includes a second display screen located on the handle portion.

In accordance with a sixteenth aspect of the present disclosure, which may be used in combination with any other aspect or combination of aspects listed herein, the display screen is located on the handle portion.

In accordance with a seventeenth aspect of the present disclosure, which may be used in combination with any other aspect or combination of aspects listed herein, the motion device includes an accelerometer.

In accordance with an eighteenth aspect of the present disclosure, which may be used in combination with any other aspect or combination of aspects listed herein, the beverage tap handle system includes a microcontroller, and wherein the microcontroller uses the motion device to determine how much of the beverage has been dispensed from the spigot.

In accordance with a nineteenth aspect of the present disclosure, which may be used in combination with any other aspect or combination of aspects listed herein, the motion device triggers the display screen to immediately change the displayed image to the new image when the handle portion is pulled to dispense the beverage.

In accordance with a twentieth aspect of the present disclosure, which may be used in combination with any other aspect or combination of aspects listed herein, the motion device triggers the display screen to change the displayed image to the new image after a time delay after the handle portion is pulled.

In accordance with a twenty-first aspect of the present disclosure, which may be used in combination with any other aspect or combination of aspects listed herein, a beverage tap handle system comprises a first tap handle, the first tap handle configured to be attached to a first spigot so that the first tap handle can be pulled to dispense a first beverage from the first spigot, the first tap handle including a first display screen configured to display at least one image from a plurality of images, a second tap handle, the second tap handle configured to be attached to a second spigot so that the second tap handle can be pulled to dispense a second beverage from the second spigot, the second tap handle including a second display screen configured to display at least one image from a plurality of images, and a controller configured to: (i) place the first tap handle in wireless communication with the second tap handle; and (ii) coordinate the at least one image displayed on the first display screen with the at least one image displayed on the second display screen.

In accordance with a twenty-second aspect of the present disclosure, which may be used in combination with any other aspect or combination of aspects listed herein, the controller is located at the first tap handle and/or the second tap handle.

In accordance with a twenty-third aspect of the present disclosure, which may be used in combination with any other aspect or combination of aspects listed herein, the controller is located at a remote location and wirelessly communicates with each of the first tap handle and the second tap handle.

In accordance with a twenty-fourth aspect of the present disclosure, which may be used in combination with any other aspect or combination of aspects listed herein, the first tap handle includes a first wireless antenna and the second tap handle includes a second wireless antenna, and wherein the first wireless antenna wirelessly communicates with the second wireless antenna to provide direct communication between the first tap handle and the second tap handle.

In accordance with a twenty-fifth aspect of the present disclosure, which may be used in combination with any other aspect or combination of aspects listed herein, settings for the display screen on the first tap handle can be transmitted to the second tap handle without a user having to program the settings into the second tap handle.

In accordance with a twenty-sixth aspect of the present disclosure, which may be used in combination with any other aspect or combination of aspects listed herein, the at least one image is loaded onto the first tap handle and then transmitted to the second tap handle by the first tap handle.

In accordance with a twenty-seventh aspect of the present disclosure, which may be used in combination with any other aspect or combination of aspects listed herein, a method of programming a tap handle to display a plurality of images comprises programming a display screen of the tap handle to display a plurality of images, and programming a trigger that causes the display screen to change a displayed image to a new image.

In accordance with a twenty-eighth aspect of the present disclosure, which may be used in combination with any other aspect or combination of aspects listed herein, the method includes loading the first image on the display screen.

In accordance with a twenty-ninth aspect of the present disclosure, which may be used in combination with any other aspect or combination of aspects listed herein, programming the trigger includes programming the trigger so that the display screen changes the displayed image to the new image when the tap handle is pulled to dispense a beverage.

In accordance with a thirtieth aspect of the present disclosure, which may be used in combination with any other aspect or combination of aspects listed herein, programming the trigger includes programming the trigger so that the display screen changes the displayed image to the new image after the displayed image has been displayed for a predetermined amount of time.

In accordance with a thirty-first aspect of the present disclosure, which may be used in combination with any other aspect or combination of aspects listed herein, programming the trigger includes programming the trigger so that the display screen changes the displayed image to the new image when a signal is received by a wireless antenna located on the tap handle.

In accordance with a thirty-second aspect of the present disclosure, which may be used in combination with any other aspect or combination of aspects listed herein, programming the trigger includes programming the trigger so that the display screen changes the displayed image to the new image when the display screen is touched by a user.

In accordance with a thirty-third aspect of the present disclosure, which may be used in combination with any other aspect or combination of aspects listed herein, the method includes displaying the new image based on a global positioning system (“GPS”).

In accordance with a thirty-fourth aspect of the present disclosure, which may be used in combination with any other aspect or combination of aspects listed herein, programming the display screen to display the plurality of images includes transmitting at least one of the plurality of images to the tap handle from another tap handle.

In accordance with a thirty-fifth aspect of the present disclosure, which may be used in combination with any other aspect or combination of aspects listed herein, programming the trigger includes transmitting at least one trigger setting to the tap handle from another tap handle.

1. A beverage tap handle system, comprising:
a handle portion that can be pulled to dispense a beverage from a spigot;
an attachment portion that attaches the handle portion to the spigot;
a display screen configured to display a plurality of images;
a motion device that signals when the handle portion is pulled to dispense the beverage; and
a controller that controls the display screen to change an image displayed on the display screen to a new image, the controller programmed to: (i) set a predetermined amount of time when the displayed image is displayed on the display screen; (ii) change the displayed image to the new image when the motion device signals that the handle portion is pulled to dispense the beverage; (iii) change the displayed image to the new image at expiration of the predetermined amount of time when the displayed image has not already been changed to the new image within the predetermined amount of time; and (iv) set another predetermined amount of time for changing the new image displayed on the display screen when the new image is displayed on the display screen.

2. The beverage tap handle system of claim 1, which includes a tower, wherein the display screen is located on the tower.

3. The beverage tap handle system of claim 1, wherein the display screen is located on the handle portion.

4. The beverage tap handle system of claim 1, wherein, after setting the another predetermined amount of time, the controller is programmed to: (a) change the new image to a second new image when the motion device signals that the handle portion is pulled to dispense the beverage; and (b) change the new image to the second new image at expiration of the another predetermined amount of time when the new image has not already been changed to the second new image within the another predetermined amount of time.

5. The beverage tap handle system of claim 1, which includes a wireless antenna, and wherein the controller is further programmed to change the displayed image to the new image when a signal is received by the wireless antenna within the predetermined amount of time.

6. The beverage tap handle system of claim 1, wherein the display screen includes a touch screen, and wherein the controller is further programmed to change the displayed image to the new image when the touch screen is touched within the predetermined amount of time.

7. The beverage tap handle system of claim 1, wherein the plurality of images includes at least one of: (i) a still image; (ii) a moving image; (iii) a video; and (iv) a text image.

8. The beverage tap handle system of claim 1, which includes a global positioning system (“GPS”) sensor, and wherein the new image is based on a reading from the GPS sensor.

9. A beverage tap handle system, comprising:
a handle portion that can be pulled to dispense a beverage from a keg via a spigot;
an attachment portion that attaches the handle portion to the spigot;
a display screen configured to display information related to the keg;
a motion device that signals when the handle portion is pulled to dispense the beverage; and
a controller that (i) uses the motion device to determine an amount of the beverage dispensed from the keg via the spigot, and (ii) causes the display screen to display information related to an amount of fluid in the keg based on the determination of the amount of the beverage dispensed from the keg via the spigot.

10. The beverage tap handle system of claim 9, which includes a tower, wherein the display screen is located on the tower.

11. The beverage tap handle system of claim 9, wherein the display screen is located on the handle portion.

12. The beverage tap handle system of claim 9, wherein the controller is configured to calibrate the motion device depending on a speed or a strength of pull on the handle portion.

13. The beverage tap handle system of claim 9, wherein the controller (a) uses the motion device to determine a flow rate of the beverage through the spigot, and (b) uses the determined flow rate to determine the information related to the amount of fluid in the keg.

14. The beverage tap handle system of claim 9, wherein the controller uses the information related to the amount of fluid in the keg to cause an alert when the keg needs to be changed.

15. A beverage tap handle system, comprising:
a first tap handle, the first tap handle configured to be attached to a first spigot so that the first tap handle can be pulled to dispense a first beverage from the first spigot, the first tap handle including a first display screen configured to display at least one image from a plurality of images;
a second tap handle, the second tap handle configured to be attached to a second spigot so that the second tap handle can be pulled to dispense a second beverage from the second spigot, the second tap handle including a second display screen configured to display at least one image from the plurality of images; and
a controller configured to: (i) place the first tap handle in wireless communication with the second tap handle; and (ii) coordinate a timing of the at least one image displayed on the first display screen with a timing of the at least one image displayed on the second display screen.

16. The beverage tap handle system of claim 15, wherein the controller is located at the first tap handle and/or the second tap handle.

17. The beverage tap handle system of claim 15, wherein the controller is located at a remote location and wirelessly communicates with each of the first tap handle and the second tap handle.

18. The beverage tap handle system of claim 15, wherein the first tap handle includes a first wireless antenna and the second tap handle includes a second wireless antenna, and wherein the first wireless antenna wirelessly communicates with the second wireless antenna to provide direct communication between the first tap handle and the second tap handle.

19. The beverage tap handle system of claim 15, wherein settings for the display screen on the first tap handle can be transmitted to the second tap handle without a user having to program the settings into the second tap handle.

20. The beverage tap handle system of claim 15, wherein at least one image from the plurality of images is loaded onto the first tap handle and then transmitted to the second tap handle by the first tap handle.

21. The beverage tap handle system of claim 15, wherein the first tap handle triggers the display timing of the at least one image on the second display screen of the second tap handle.
